(19) United States
(12) Patent Application Publication
(10) Pub. No.: US 2014/0272290 A1
(43) Pub. Date: Sep. 18, 2014

(54) Polymer Anti-glare Coatings and Methods for Forming the Same

(71) Applicant: INTERMOLECULAR INC., San Jose, CA (US)

(72) Inventors: Scott Jewhurst, Redwood City, CA (US); Nikhil Kalyankar, Mountain View, CA (US); Minh Huu Le, San Jose, CA (US)

(73) Assignee: INTERMOLECULAR INC., San Jose, CA (US)

(21) Appl. No.: 13/838,170

(22) Filed: Mar. 15, 2013

(51) Int. Cl. C09D 167/02; C09D 127/20; C09D 127/18

(52) U.S. Cl. CPC C09D 167/02; C09D 127/18; C09D 127/20
USPC 428/141; 428/339; 428/421; 428/521; 204/192.1

(57) ABSTRACT

Embodiments provided herein describe anti-glare coatings and panels and methods for forming anti-glare coatings and panels. A transparent substrate is provided. A polymer is sputtered onto the transparent substrate to form an anti-glare coating on the transparent substrate.

The present invention relates to optical coatings. More particularly, this invention relates to anti-glare coatings made from polymers and methods for forming such anti-glare coatings.

### BACKGROUND OF THE INVENTION

Anti-glare coatings (or surfaces), and anti-glare panels in general, are desirable in many applications including, portrait glass, privacy glass, and display screen manufacturing. Such optical coatings scatter specular reflections into a wide viewing cone to diffuse glare and reflection.

The processes used to form such coatings and/or surfaces are typically very complex and expensive. For example, anti-glare surfaces for glass substrates are typically produced by acid etch texturing of the glass surface. The resulting surface is typically very hydrophilic and requires additional treatment with fluorosilanes or deposition of fluoropolymer by chemical vapor deposition (CVD) to render it repellent to dust, water, and other soiling agents. As another example, anti-glare coatings for polymer surfaces are typically produced by wet deposition of transparent polymers that contain light scattering particles (e.g., polymer, oxide or both). These coatings are typically cured by exposure to radiation (e.g., ultra-violet (UV) or electron-beam) or thermal processing. In some cases, thermal processing also uses a chemical initiator (i.e., for organic cross-linking) or a catalyst (i.e., for inorganic cross-linking). In order to create anti-soiling properties, the addition of a fluorosurfactant or deposition of a fluoropolymer topcoat may be required. Further, anti-glare coatings for glass may be formed using sol-gel or organic-inorganic hybrid coatings containing light scattering particles (e.g., oxide and/or polymer). These anti-soiling formulations are typically complex, moisture-sensitive, and may be difficult to create. Thermal curing, or a combination of thermal curing and UV curing, may also be required.

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is a cross-sectional view of a substrate with an anti-glare coating formed thereon according to some embodiments of the present invention.

FIG. 2 is a simplified cross-sectional diagram of a physical vapor deposition (PVD) tool according to some embodiments of the present invention.

FIG. 3 is a flow chart of a method for forming an anti-glare coating according to some embodiments of the present invention.

### DETAILED DESCRIPTION

A detailed description of one or more embodiments is provided below along with accompanying figures. The detailed description is provided in connection with such embodiments, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

Embodiments of the invention provide optical coatings that improve the anti-glare performance of transparent substrates. In accordance with some embodiments, this is accomplished by sputtering one or more polymers onto a transparent substrate to form an anti-glare coating. In some embodiments, the anti-glare coating may have a thickness and a surface roughness suitable for providing anti-glare functionality and may also exhibit significant anti-soiling characteristics, both of which may be tuned by adjusting the parameters of the sputtering process used.

Forming anti-glare coatings in such a manner allows for a single step process to be used in contrast with multi-step processes, thus simplifying and reducing the costs of manufacturing. Additionally, because no curing or heat treatment is necessary, the polymer anti-glare coatings may be deposited on temperature-sensitive substrates, such as tempered glass, ultra-thin glass, amorphous polymer, and/or single-crystal dielectric metal oxide.

The refractive index of the anti-glare coatings may be tuned by choice of polymer or through co-sputtering of two or more polymers. For example, the anti-glare coatings may be formed such that the refractive index is lower at the upper portions thereof (i.e., farther from the substrate) to provide anti-reflection properties. Multiple roughness scales may be created by control of deposition conditions and/or multiple sputtering steps, which allows further control of anti-glare properties and anti-soiling properties.

Additionally, because no curing or heat treatment is necessary after deposition, temperature sensitive substrates (e.g., polymers, tempered glass, etc.) may be used. The sputter process also creates reactive polymer fragments from a solid polymer target, which can covalently bond with themselves and potentially the substrate surface.

FIG. 1 illustrates a portion of an anti-glare panel 100, according to some embodiments. The panel 100 includes a transparent substrate 102 and an anti-glare coating 104 formed on an upper surface of the transparent substrate 102. In some embodiments, the transparent substrate 102 is made of glass (e.g., annealed or tempered) and has a thickness 106 of, for example, between 0.1 and 2.0 centimeters (cm). In some embodiments, the transparent substrate is made of, for example, ultra-thin glass, amorphous polymer, and/or single-crystal dielectric metal oxide. The transparent substrate may have a refractive index of, for example, between 1.3 and 1.6, and perhaps as high as 3.0, depending on the material used. Although only a portion of the panel 100 is shown, it should be understood that the panel 100 (and/or the transparent substrate 102) may, in some embodiments, have a width of, for example, between 5.0 cm and 2.0 meters (m).

In some embodiments, the anti-glare coating 104 includes (i.e., is made of) one or more polymers. For example, in some embodiments, the anti-glare coating is made of a single polymer, while in some embodiments, the anti-glare coating is made of a combination of two or more polymers. The polymer(s) used may be selected such that the anti-glare coating 104 is transparent after the polymer(s) are deposited under the conditions described herein. Suitable polymers may have a refractive index of between 1.25 and 1.65, be low surface energy polymers (e.g., having a surface energy of less than 30 dynes per centimeter, such as between 5.0 and 25.0 dynes per centimeter), and/or demonstrate anti-soiling and/or hydrophobic characteristics (e.g., having a water contact angle (θ_{w}) between 90° and 150°), at least after being sputtered in the manner described herein. Examples of suitable polymers include polytetrafluoroethylene (PTFE), fluorinated ethylene propylene (FEP), polyethylene terephthalate (PET), and fluoroacrylate. However, this list should not be considered limiting, as a wide variety of polymers may be used.

In some embodiments, the anti-glare coating 104 is formed by sputtering the polymer(s) onto the transparent substrate 102. Examples of suitable sputtering processes include, but are not limited to, radio frequency (RF) sputtering, ion beam sputtering (IBS), and plasma polymerization (or a combination thereof), which may be performed at ambient/room temperatures, or between 25° C. and 250° C. As such, the deposition of the polymer(s) may be performed at temperatures well below the softening or melting point of, for example, polymers, thus making the process compatible with various transparent substrates. In some embodiments, after the deposition of the polymer(s) onto the transparent substrate, no additional processing may be needed (i.e., the deposition of the polymer(s) alone may be sufficient to form a suitable anti-glare coating).

Still referring to FIG. 1, in some embodiments, the anti-glare coating 104 has a thickness 108 which ranges between, for example, 1.0 and 100.0 micrometers (μm). As shown, an upper surface 110 of the anti-glare coating 104 has a series a surface features 112 (i.e., texturing or roughness), which causes the thickness 108 to vary. In some embodiments, due to the features 112, the upper surface 110 of the anti-glare coating 104 may have a surface roughness (e.g., root mean squared surface roughness (R_{RMS})) ranging from, for example, 400 to 800 nm.

The use of sputtering to form the anti-glare coating 104 allows rough textured surfaces (i.e., the surface features 112) suitable for providing glare reduction and soiling resistance, with minimal loss of transparency, to be formed. That is, control of the deposition conditions allows manipulation of the morphology of the deposited polymer so that the anti-glare coating 104 forms a rough surface due to the nucleation of particles of the polymer above and on the substrate surface, rather than a smooth film.

For example, control of deposition pressure and/or power may be used to manipulate the particle size of the deposited polymer(s) and the roughness of the resulting surface, with the particle size and roughness increasing with increasing deposition pressure, sputter power and substrate-to-target distance. The effect of increasing roughness with a transparent polymer (e.g., amorphous or nanocrystalline) into the range of hundreds of nanometers or greater causes incident light to be diffusely scattered instead of being specularly reflected, thus reducing glare. Hydrophobic polymers may also exhibit increased hydrophobic effect due to the entrapment of air (Cassie-Baxter wetting), potentially to the point of superhydrophobicity (i.e., θ_{w} of more than 150°.

Generally, a rough surface reaches a glare-free condition when the incident light is phase shifted (σ_{φ}) by 2π, resulting in diffuse scattering the incident light (with incident angle Φ), a condition which is met when the root mean square roughness (σₕ) is on the order of the wavelengths (λ) of the incident light, which is expressed as:

σ_{φ}=(2π/λ)σₕ cos Φ (1)

Roughness on this length scale (e.g., 400-800 nm), combined with the inherent low surface energy of the polymer(s), may also create a superhydrophobic and oleophobic (i.e., oil-repellent, such as by having a contact angle with the particular soiling material of 90° of greater) surface that is resistant to soiling (e.g., from dust, fingerprints, water, etc.) and easy to clean. The rough surface allows a reduction in the contact area between a soiling agent and the polymer coating, also potentially trapping air in the space below the soiling agent and the contact points with the polymer, allowing the soiling agent to be removed even with gentle force.

When the soiling agent is a liquid, such as water, this wetting behavior is described by the Cassie-Baxter model, where the effective contact angle (θ_{A}) is related to the area of the solid-liquid interface (f₁) and the liquid-air interface (f₂) by the following equation

cos θ_{A}=f₁ cos θ−f₂ (2)

and θ, the contact angle, is described by Young's Equation:

cos θ=(γₛₐ−γₛₗ)/γₗₐ (3)

where γ is the interfacial energy/surface tension between the solid-air (γₛₐ), solid-liquid (γₛₗ) and liquid-air interfaces (γₗₐ).

FIG. 2 provides a simplified illustration of a physical vapor deposition (PVD), or sputter, tool (and/or system) 200 which may be used to form the anti-glare panel 100 and/or the anti-glare coating 104 described above, in accordance with some embodiments of the invention. The PVD tool 200 shown in FIG. 2 includes a housing 202 that defines, or encloses, a processing chamber 204, a substrate support 206, a first target assembly 208, and a second target assembly 210.

The housing 202 includes a gas inlet 212 and a gas outlet 214 near a lower region thereof on opposing sides of the substrate support 206. The substrate support 206 is positioned near the lower region of the housing 202 and is configured to support a substrate 216. The substrate 216 may be a round glass substrate (or a substrate made of the other materials described above) having a diameter of, for example, about 200 mm or about 300 mm. In some embodiments (such as in a manufacturing environment), the substrate 216 may have other shapes, such as square or rectangular, and may be significantly larger (e.g., about 0.5-about 6 m across). Additionally, in some embodiments, substrates suitable for roll-to-roll coating and in-line coating may be used. The substrate support 206 includes a support electrode 218 and is held at ground potential during processing, as indicated.

The first and second target assemblies (or process heads) 208 and 210 are suspended from an upper region of the housing 202 within the processing chamber 204. The first target assembly 208 includes a first target 220 and a first target electrode 222, and the second target assembly 210 includes a second target 224 and a second target electrode 226. As shown, the first target 220 and the second target 224 are oriented or directed towards the substrate 216. As is commonly understood, the first target 220 and the second target 224 include one or more materials that are to be used to deposit a layer of material 228 on the upper surface of the substrate 216. Although not shown, in some embodiments, the first and second target assemblies 208 and 210 also include one or more magnets.

The materials used in the targets 220 and 224 may be, for example, polymers such as polytetrafluoroethylene (PTFE), fluorinated ethylene propylene (FEP), polyethylene terephthalate (PET), fluoroacrylate, or any combination thereof (i.e., a single target may be made of several polymers). Additionally, although only two targets 220 and 224 are shown, additional targets may be used in some embodiments, while in some embodiments, only a single target may be used. As such, different combinations of targets may be used to form, for example, the anti-glare coatings described above.

The PVD tool 200 also includes a first power supply 230 coupled to the first target electrode 222 and a second power supply 232 coupled to the second target electrode 226. Although not shown, it should be understood that the first power supply 230 and/or the second power supply 232 may also be coupled to the housing 202 and/or the substrate support 206. During sputtering, an inert gas, such as argon or krypton, may be introduced into the processing chamber 204 through the gas inlet 212, while a vacuum is applied to the gas outlet 214. Ions within the inert gas bombard the targets 220 and 224, causing material to be sputtered (or co-sputtered), or ejected, from the first target 220 and/or the second target 224 (and onto the substrate 216). In the case of RF sputtering, the power supplies 230 and 232 provide power to the first and second targets 220 and 224 while alternating the potential between the targets 220 and 224 and the housing 202 and/or the substrate support 206. In some embodiments, the PVD 200 also includes a ion source/gun (i.e., IBS) or a plasma source (i.e., plasma polymerization) to facilitate the deposition process.

Although not shown in FIG. 2, the PVD tool 200 may also include a control system having, for example, a processor and a memory, which is in operable communication with the other components shown in FIG. 2 and configured to control the operation thereof in order to perform the methods described herein. Further, although the PVD tool 200 shown in FIG. 2 includes a stationary substrate support 206, it should be understood that in a manufacturing environment, the substrate 216 may be in motion during the various layers described herein.

FIG. 3 is a flow chart illustrating a method 300 for forming an anti-glare coating according to some embodiments of the present invention. The method 300 begins at block 302 by providing a transparent substrate such as the examples described above (e.g., glass).

At block 304, a polymer (or more than one polymer) is sputtered onto the transparent substrate. As described above, the polymer(s) may include PTFE, FEP, PET, and/or fluoroacrylate, or any other polymer(s) which will form a transparent anti-glare coating after being deposited as described above. The sputtering process may be performed according to the details provided above using, for example, the PVD tool 200 shown in FIG. 2.

At block 306, the method 300 ends as, in at least some embodiments, the sputtered polymer(s) complete the formation of an anti-glare coating. That is, no additional processing, such as curing, may be required.

Thus, in some embodiments, a method for forming an anti-glare coating is provided. A transparent substrate is provided. A polymer is sputtered onto the transparent substrate to form an anti-glare coating on the transparent substrate.

In some embodiments, a method for forming an anti-glare coating is provided. A transparent substrate is provided. A polymer is sputtered onto the transparent substrate to form an anti-glare coating on the transparent substrate. The sputtering of the polymer is performed at a temperature of between 25° C. and 250° C. The anti-glare coating has a surface roughness of between 400 and 800 nm.

In some embodiments, an anti-glare panel is provided. The anti-glare panel includes a transparent substrate and an anti-glare coating formed on the transparent substrate. The anti-glare coating includes a polymer.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method for forming an anti-glare coating comprising:
providing a transparent substrate; and
sputtering a polymer onto the transparent substrate to form an anti-glare coating on the transparent substrate.

2. The method of claim 1, wherein the anti-glare coating has a thickness of between 1.0 and 100.0 micrometers (μm).

3. The method of claim 2, wherein the anti-glare coating has a surface roughness of between 400 and 800 nanometers (nm).

4. The method of claim 1, wherein the polymer is selected such that the anti-glare coating is transparent after the sputtering of the polymer onto the transparent substrate.

5. The method of claim 1, wherein the polymer has a surface energy of less than 30 dynes per centimeter.

6. The method of claim 1, wherein the polymer comprises polytetrafluoroethylene (PTFE), fluorinated ethylene propylene (FEP), polyethylene terephthalate (PET), fluoroacrylate, or a combination thereof.

7. The method of claim 1, wherein the sputtering of the polymer is performed at a temperature of between 25° C. and 250° C.

8. The method of claim 1, wherein the transparent substrate comprises glass, amorphous polymer, single-crystal dielectric metal oxide, or a combination thereof.

9. The method of claim 1, wherein the polymer has a refractive index between 1.25 and 1.65.

10. The method of claim 1, wherein the sputtering of the polymer onto the surface of the substrate comprises simultaneously sputtering a first polymer and a second polymer onto the surface of the substrate.

11. A method for forming an anti-glare coating comprising:
providing a transparent substrate; and
sputtering a polymer onto the transparent substrate to form an anti-glare coating on the transparent substrate, wherein the sputtering of the polymer is performed at a temperature of between 25° C. and 250° C. and the anti-glare coating has a surface roughness of between 400 and 800 nanometers (nm).

12. The method of claim 11, wherein the polymer is selected such that the anti-glare coating is transparent after the sputtering of the polymer onto the transparent substrate.

13. The method of claim 12, wherein the polymer has a surface energy of less than 30 dynes per centimeter.

14. The method of claim 12, wherein the polymer comprises polytetrafluoroethylene (PTFE), fluorinated ethylene propylene (FEP), polyethylene terephthalate (PET), fluoroacrylate, or a combination thereof.

15. The method of claim 13, wherein the anti-glare coating has a thickness of between 1.0 and 100.0 micrometers (μm).

16. An anti-glare panel comprising:
a transparent substrate; and
a polymer anti-glare coating formed on the transparent substrate, wherein the polymer anti-glare coating is sputtered onto the transparent substrate.

17. The anti-glare panel of claim 16, wherein the polymer anti-glare coating comprises a polymer that has a surface energy of less than 30 dynes per centimeter.

18. The anti-glare panel of claim 16, wherein the anti-glare coating has a thickness of between 1.0 and 100.0 micrometers (μm).

19. The anti-glare panel of claim 17, wherein the anti-glare coating has a surface roughness of between 400 and 800 nanometers (nm).

20. The anti-glare panel of claim 16, wherein the polymer has a refractive index between 1.25 and 1.65.
